(19) United States
(12) Patent Application Publication
(10) Pub. No.: US 2008/0162780 A1
(43) Pub. Date: Jul. 3, 2008

(54) INFORMATION TERMINAL APPARATUS

(76) Inventors: Nobuaki Kohinata, Yokohama (JP); Mika Mizutani, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/958,409

(22) Filed: Dec. 18, 2007

(30) Foreign Application Priority Data
Dec. 19, 2006 (JP) 2006-340672

(51) Int. Cl. G06F 12/00

(52) U.S. Cl. 711/100; 711/E12.001

(57) ABSTRACT

An electronic data storage system using an electronic tally system capable of managing electronic data in a safe manner without deteriorating a user friendly function thereof, and an information terminal apparatus to which the electronic data storage system has been applied are provided. An information terminal apparatus includes an electronic tally processing unit, a data storage unit, a data input/output unit and an access control unit for controlling a reading operation of the electronic tallied data which is stored in the data storage unit.

### INCORPORATION BY REFERENCE

The present application claims priority from Japanese application JP 2006-340672 filed on Dec. 19, 2006, the content of which is hereby incorporated by reference into this application.

### BACKGROUND OF THE INVENTION

1. Field of the Invention

The present invention relates to an information terminal apparatus with employment of an electronic tally system capable of managing electronic data in a safe manner, while a user friendly function thereof is not deteriorated.

2. Description of the Related Art

Very recently, portable information terminal apparatuses such as portable telephones, PDAs (Personal Data Assistants), and notebook type PCs (Personal Computers) have been manufactured with higher functions, and storage capacities of non-volatile memories equipped in these portable information terminal apparatuses, so that various sorts of information can be carried with users. As a result, flow-out aspects of information from these information terminal apparatuses frequently occur, which are caused by losing, or being stolen, these information terminal apparatuses, recently, and/or caused by computer virus. Under such a circumstance, protections of information may once more become important.

As access controls for, for example, personal information (telephone directory, address directory, mail list, mail addresses, schedules and so on.) which is stored in non-volatile memories (semiconductor flash memories, hard disk drives or the like.) equipped in these information terminal apparatuses, password authentication and biological authentication have already been proposed. Thus, electronic appliances equipped with such access controlling functions have been widely and commercially available. However, since the above-described personal information stored in these electronic appliances has been formed in perfect data modes, there are then some risks in that the personal information may flow out by such a way that the non-volatile memories are disconnected from the information terminal apparatuses so as to copy these electronic data, and/or these data are influenced by computer virus.

As technical ideas capable of avoiding these risks, electronic tally systems based upon secret distributing systems have been known in this field. The electronic tally systems imply the following electronic system: That is, various sorts of electronic data handled by the information terminal apparatuses are stirred to be sub-divided into at least 2 pieces of electronic data in accordance with a predetermined scheme. As a result, the electronic data can be managed and held in imperfect data modes, so that security of the electronic data can be improved.

On the other hand, JP-A-2002-351845 discloses such a portable telephone to which an electronic tally system has been applied. In the disclosed portable telephone, electronic data divided in accordance with the electronic tally system are stored in both an internal memory provided in this portable telephone and a detachable external memory; and a user separately manages the portable telephone main body or the detachable external memory in order to secure security of these electronic data.

However, in accordance with this portable telephone, since the portable telephone main body and the external memory must be possessed in a separate manner, there is a problem that the cumbersome management by the user is necessarily required, and thus, user friendly functions are deteriorated. In such a case that the user leaves the external memory at some place, and/or this external memory is stolen, there is another problem that the original electronic data cannot be restored.

Also, JP-A-2002-351845 has disclosed another portable telephone. That is, the electronic data divided based upon the electronic tally system are stored in both the internal memory provided in this portable telephone and a server communicated therewith via a communication network in order to solve the cumbersome management made by the user.

However, in accordance with the above-described portable telephone, when a communication cannot be established between the server and the own portable telephone, the desirable electronic data cannot be restored. Also, there is another problem that since an overhead related to the communication time with the server may occur, a lengthy time necessary for restoring the desirable electronic data is necessarily required, so that the user friendly function of the portable telephone is still deteriorated.

In addition to the above-described problems, JP-A-2002-351845 does not disclose a concrete managing method for managing the electronic tallied data which are produced by the electronic tally system even in any of these portable telephones, for instance, a managing method for managing such an information related to corresponding relationships among the electronic tallied data.

On the other hand, in such information terminal apparatuses to which the electronic tally system is applied, the below-mentioned technical aspects must be considered.

First of all, if the respective electronic tallied data produced in accordance with the electronic tally system are separately managed, then there is such a problem that metainformation related to data management is increased. In other words, since the electronic tally system is applied to such an electronic data whose quantity is originally 1 piece, this 1 electronic data is divided into a plurality of divided electronic tallied data. As a result, such a metainformation is required for the respective plural electronic tallied data. Furthermore, the correspondence relationship between the original electronic data and these electronic tallied data must be held. Accordingly, different from such an information terminal apparatus (desktop PC, notebook type PC and so on.) equipped with a large memory capacity and higher processor performance, for example, in such an assembled electronic appliance (portable telephone) that resources are limited, electronic data must be managed through a processor having low-graded processing performance and a small memory capacity.

Also, there is a further problem that a use efficiency of a recording device for recording the electronic data is tend to be lowered. Normally, in recording devices, minimum recording units (sizes) are present, for instance, a minimum recording unit (size) of an HDD (hard disk drive) is defined as 512 bytes equal to a sector size thereof, and a minimum recording unit of a semiconductor flash memory is defined as 512 bytes equal to a page size thereof. Accordingly, even when a size of electronic data is smaller than the above-explained minimum recording unit, a fraction data portion which is less than the minimum recording unit may consume such a recording area of the above-described minimum recording unit. Also, even when electronic data having a data size larger than the minimum recording unit is recorded, a fraction data portion which is less than the minimum recording unit may consume such a recording area of the above-described minimum recording unit. As a consequence, even in such a case that since the electronic tally system is applied to the electronic data, this electronic data is divided into the plurality of electronic tallied data, the user efficiency of the recording device must not be lowered.

Also, in order to improve a so-called anti-tamper characteristics, higher costs are required and processing loads tend to be increased. As a result, it is required to provide such a method capable of improving the anti-tamper characteristics in higher efficiencies as being permitted as possible.

### SUMMARY OF THE INVENTION

As previously described, an object to be achieved by the present invention is to improve a user friendly function of an information terminal apparatus by securing a security even when electronic tallied data are stored in the physically same recording device. Also, another object is to manage electronic data of the information terminal apparatus in a higher efficiency by managing electronic data to which an electronic tally system is applied, and also, electronic data to which the electronic tally system in not applied based upon simple metainformation. Also, another object is not to lower a use efficiency of the recording device. A further object is to provide a method capable of improving an anti-tamper characteristic as to the electronic tallied data in an effective manner.

At least any one of the above-described objects can be achieved by the present invention recited in the scope of claims for a patent.

In accordance with the present invention, such an information terminal apparatus capable of improving the security and also the user friendly function can be provided.

### BRIEF DESCRIPTION OF THE DRAWINGS

FIG. 1 is a diagram for explaining an arrangement and operations of an information terminal apparatus according to a first embodiment of the present invention.

FIG. 2 is a diagram for explaining a structure of management information which is managed by a data managing unit of the information terminal apparatus according to the first embodiment of the present invention.

FIG. 3 is a diagram for supplementarily describing the structure of the management information which is managed by the data managing unit of the information terminal apparatus according to the first embodiment of the present invention; namely, a diagram for exemplifying such a case related to data to which the electronic tally system is not applied.

FIG. 4 is a diagram for supplementarily describing the structure of the management information which is managed by the data managing unit of the information terminal apparatus according to the first embodiment of the present invention; namely, a diagram for exemplifying such a case related to data to which the electronic tally system is applied.

FIG. 5 is a diagram for describing statuses and a status transition, which are managed by an access control unit of the information terminal apparatus according to the first embodiment of the present invention.

FIG. 6 is a diagram for describing a portable telephone apparatus which corresponds to a concrete application example as to the information terminal apparatus according to the first embodiment of the present invention.

FIG. 7 is a diagram for explaining an arrangement and operations of an information terminal apparatus according to a second embodiment of the present invention.

FIG. 8 is a diagram for explaining a structure of management information which is managed by a data managing unit of the information terminal apparatus according to the second embodiment of the present invention.

### DETAILED DESCRIPTION OF THE EMBODIMENTS

Referring now to drawings, various embodiments of the present invention will be described hereinafter.

### First Embodiment

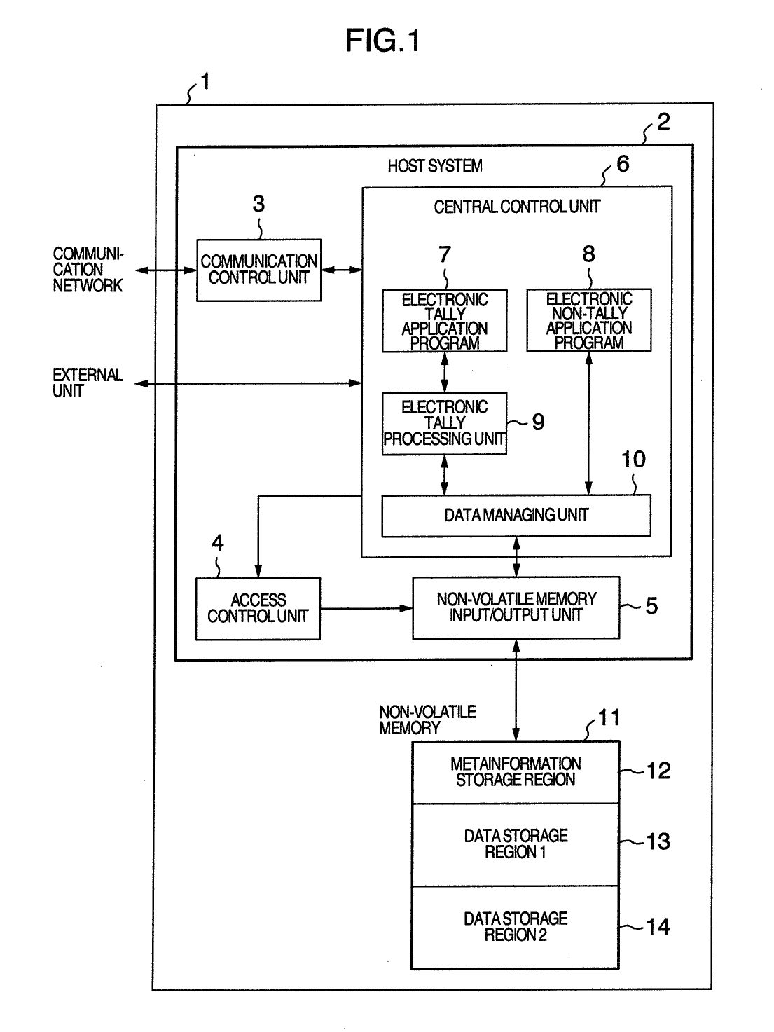

FIG. 1 represents an information terminal apparatus 1 to which an electronic tally system has been applied, according to a first embodiment of the present invention.

Firstly, a description is made of an arrangement of the information terminal apparatus 1 with reference to FIG. 1.

As shown in the drawing, the information terminal apparatus 1 is arranged by a host system 2, and a non-volatile memory 11. The host system 2 is arranged by a communication control unit 3, a central control unit 6, an access control unit 4, and a non-volatile memory input/output unit 5. The communication control unit 3 is employed in order that the information terminal apparatus 1 transmits/receives information with respect to an external unit (not shown) through a communication network. The central control unit 6 controls various sorts of functions provided in the information terminal apparatus 1 in accordance with a user instruction given as an external input and reception notification issued by the communication control unit 3; and manages information and/or statuses related to the above-described control operations; and further, executes an electronic tally application program 7 and an electronic non-tally application program 8. The access control unit 4 is equipped with an authentication function which confirms justification of a user instruction given via the central control unit 6. The access control unit 4 provides a status signal with respect to the non-volatile memory input/output unit 5 in accordance with the authenticated user instruction and notification which is issued by the central control unit 6 in response to the above-described reception notification issued by the communication control unit 3 as an origination factor. The status signal provided by the access control unit 4 is used in order to judge an execution for reading data from a specific region of the non-volatile memory 11. The non-volatile memory input/output unit 5 provides a physical interface to a non-volatile memory 11 based upon the status signal issued by the access control unit 4, a write instruction and a write destination address, or a read instruction and a read destination address. The write instruction and the write destination address are given from the central control unit 6 so as to store various sorts of electronic data handled by the information terminal apparatus 2 into the non-volatile memory 11. The read instruction and the read destination address are given from the central control unit 6 so as to read out various sorts of electronic data from the non-volatile memory 11.

Also, the central control unit 6 of the host system 2 is arraigned by an electronic tally application program 7, an electronic non-tally application program 8, an electronic tally processing unit 9, and a data managing unit 10. As to the electronic data related to personal information of a user who possesses the information terminal apparatus 1, for example, a telephone directory, an address directory, a schedule, electronic mail addresses, and the mail content thereof, these electronic data must be protected from various factors for acquiring them by a third party in an illegal manner, and also, these electronic data flow outside the information terminal apparatus 1 without any intention by the user, while such an electronic data will be referred to as “electronic tally-subject data” hereinafter. The electronic tally application program 7 newly adds, updates, deletes, and refers to the electronic tally-subject data. On the other hand, while any other electronic data than the above-described electronic tally-subject data will be referred to as “electronic non-tally-subject data” hereinafter, the electronic non-tally application program 8 newly adds, updates, deletes, and refers to such electronic non-tally-subject data. The electronic tally processing unit 9 stirs the above-described electronic tally-subject data, and divides the stirred electronic tally-subject data in an arbitrary size, into at least “N”, or more pieces of data (symbol “N” being an integer larger than 1) by a predetermined scheme based upon a secret distributing method in conjunction with the electronic tally application program 7 so as to produce a plurality of electronic tallied data. Also, the electronic tally processing unit 9 restores the original electronic tally-subject data from the above-explained electronic tallied data. The data managing unit 10 adds, updates, and saves management information so as to achieve the below-mentioned purposes: That is, when the electronic tallied data and the electronic non-tally-subject data are written and/or read in/from the non-volatile 11, the data managing unit 10 determines a storage location within the non-volatile memory 11, and/or specifies a storage location by converting a physical address.

Then, the non-volatile memory 11 is constituted by a metainformation storage region 12, a data storage region 1 (13), and another data storage region 2 (14). The metainformation storage region 12 is provided in order to store thereinto the management information handled by the above-described data managing unit 10, and has been allocated to continuous physical address spaces. The data storage region 1 (13) is employed in order to store thereinto “M” pieces (N>M>0) of the electronic tallied data among “N” pieces (N>1) of the electronic tallied data, the electronic non-tally-subject data, and furthermore, various sorts of application programs which are executed in the central control unit 6. This data storage region 1 (13) has been allocated to continuous physical address spaces. Also, the data storage region 2 (14) is employed in order to store thereinto (N-M) pieces of the above-explained electronic tallied data, and has also been allocated to continuous physical address spaces. Since the non-volatile memory 11 is constructed in the above-described manner, even if the anti-tamper characteristics as to all of the storage regions of the non-volatile memory 11 are not improved, it is possible to avoid that such an information to be protected is disclosed in an illegal manner by merely improving only the anti-tamper characteristic of the data storage region 2 (14). Also, since data which have not been electronically tallied are stored in the data storage region 1 (13), there is no need that the electronic tally processing unit 9 unnecessarily performs an electronic tally processing operation. As a result, the loads given to the information terminal apparatus 1 can be reduced, and in addition, it is possible to avoid that the above-described information to be protected is disclosed in the illegal manner.

It should be understood that as to region sections of the non-volatile memory 11, the structure thereof is determined when the non-volatile memory 11 is formatted.

Although has been omitted in FIG. 1, such an management information to be stored in the metainformation storage region 12 is loaded in a high-speed accessible volatile memory provided in the host system 2 when the power supply of the information terminal apparatus 1 is turned ON, and the management information of the volatile memory is updated to be viewed by the data managing unit 10 during operation term. Then, the management information of the volatile memory is rewritten into the metainformation storage region 12 by the data managing unit 10 every time a predetermined time period has elapsed even when the power supply is cut off, and even during the operation term.

Then, the non-volatile memory 11 of the information terminal apparatus 1 to which the electronic tally system has been applied, according to the first embodiment of the present invention, corresponds to a semiconductor flash memory, while there is such a feature that respective boundaries among the metainformation storage region 12, the data storage 1 (13), and the data storage region 2 (14) are made coincident with boundaries of erasing blocks of the semiconductor flash memory. As a result, for instance, when the storage content of the metainformation storage region 12 is updated, it is possible to suppress a total number of unnecessary block erasing operations with respect to the data storage region 1 (13) in conjunction with read, modify, write operations, so that a lifetime of the semiconductor flash memory can be prolonged. The arrangements of the information terminal apparatus 1 have been described in the above descriptions.

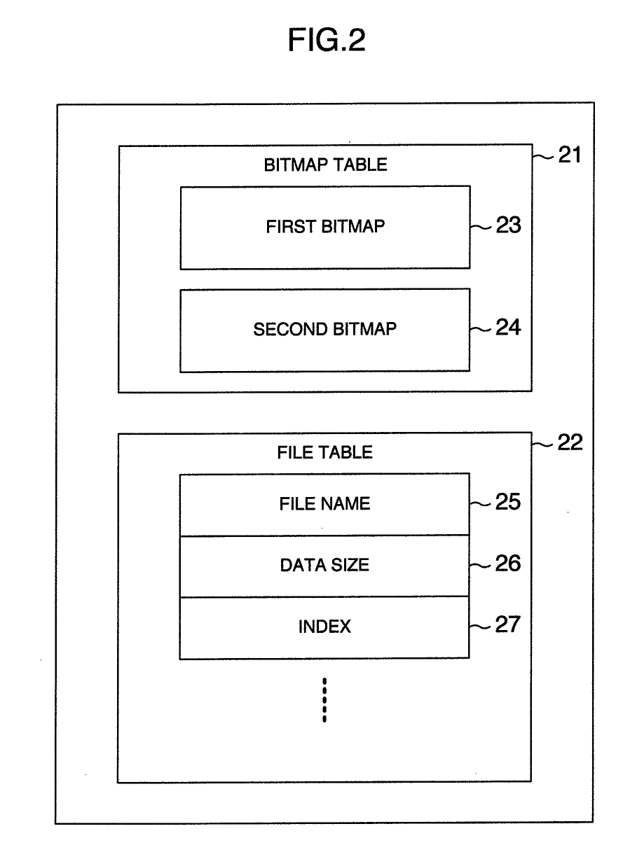

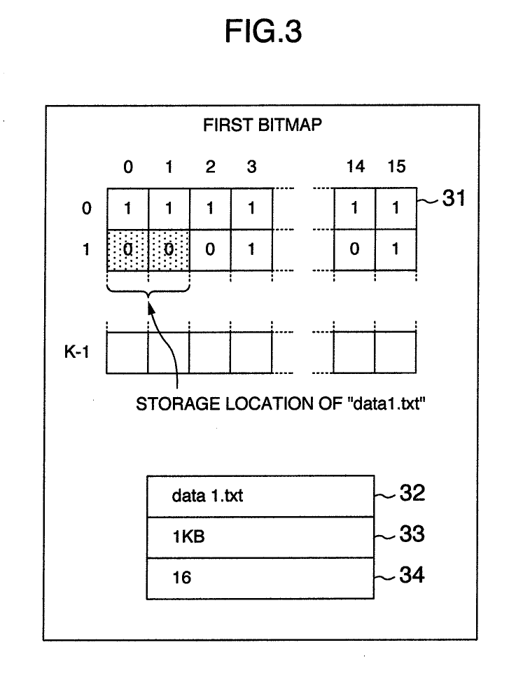

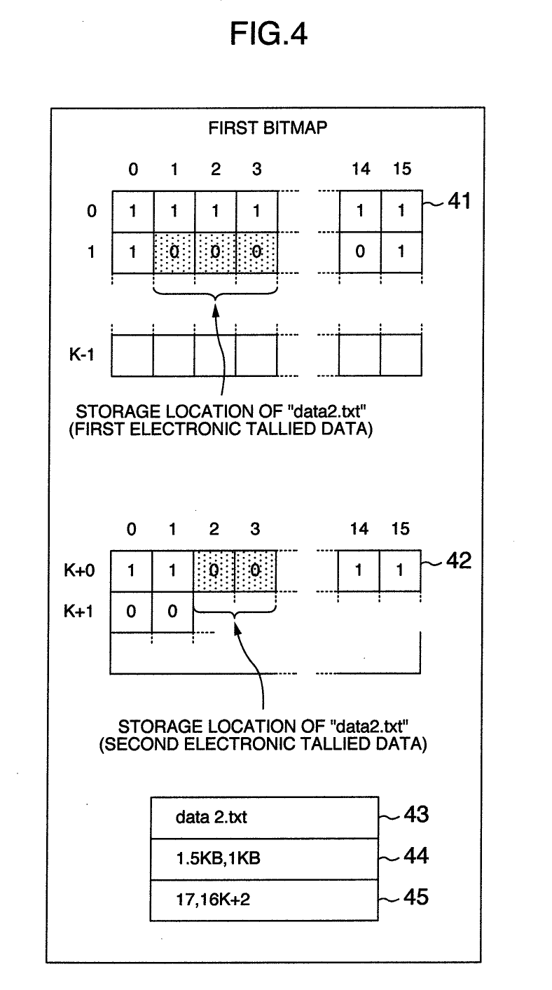

Next, a description is made of structures of the management information possessed by the data storage unit 10 shown in FIG. 1 with reference to FIG. 2, FIG. 3, and FIG. 4.

Firstly, as shown in FIG. 2, the management information is constituted by a bitmap table 21 and a file table 22.

The above-described bitmap table 21 is constituted by a first bitmap 23, and a second bitmap 24. While a minimum recording unit (for instance, 512 bytes equal to page size, or multiple of 512 bytes) of the non-volatile memory 11 indicated in FIG. 1 is employed as a reference, the first bitmap 23 represents a use condition of the data storage region 1 (13) as either “1 (used)” or “0 (non-used).” The second bitmap 24 represents a use condition of the data storage region 2 (13) as either “1 (used)” or “0 (non-used).” Also, the above-described file table 22 is constituted by at least a file name 25 of electronic data (either electronic tally-subject data or electronic non-tally-subject data), a data size 26 of the electronic data, and an index 27 every the above-described electronic data. The index 27 stores thereinto both a bitmap number indicative of a head of a storage location in the data storage region 1 (13) shown in FIG. 1, and a bitmap number indicative of a head of a storage location in the data storage region 2 (14).

As to the above-described data size 26, in such a case that electronic data to be processed is electronic non-tally-subject data, at least 1 value is described. Also, in the case that the above-described electronic data is electronic tally-subject data and has been divided into “N” (N>1) pieces of electronic data, at least “N” pieces of values are described.

Further, as to the above-explained index 27, in such a case that electronic data to be processed is electronic non-tally-subject data, at least 1 value is described. Also, in the case that the above-described electronic data is electronic tally-subject data and has been divided into “N” (N>1) pieces of electronic data, at least “N” pieces of values are described, and a total number of values to be described corresponds to the above-described data size.

As an example, a description is made of detailed contents of a bitmap table and a file table which are equal to management information related to “data1.txt” corresponding to one certain electronic non-tally-subject data with reference to FIG. 3. It should also be noted that in FIG. 3, only the first bitmap 31 has been described.

As represented in FIG. 3, “data1.txt” is described as a file name 32; for instance, 1 KB is defined as a data size 33; and also, electronic non-tally-subject data is stored only in the data storage region 1 (13) shown in FIG. 1. As a result, as an index, “16” is described which corresponds to a bitmap number indicative of a head of a storage location by the first bitmap 31.

Also, as another example, a description is made of contents of both a bitmap table and a file table, which are equal to management information related to “data2.txt” corresponding to certain one electronic tally-subject data with reference to FIG. 4.

As shown in FIG. 4, assuming now that “data2.txt” is described as a file name 43 and this data has been divided into two pieces of electronic tallied data, as a data size 44, for example, 1.5 KB and 1 KB are described, and then, since the first electronic tallied data is stored in the data storage region 1 (13) shown in FIG. 1, 17 is described as an index, which corresponds to a bitmap number indicative of a head of a storage location by a first bitmap 41. Since the second electronic tallied data is stored in the data storage region 2 (14) shown in FIG. 1, (16K+2) (K>1) is described as an index, which corresponds to a bitmap number indicative of a head of a storage location by a second bitmap 42. The structures as to the management information have been described in the above-explained descriptions.

In this example, if a size of data which are stored in the data storage region 2 (14) is continuously made constant (namely, 1 KB in example of FIG. 4), then the data can be stored in this data storage region 2 (14) in a correct rule. Also, a total number of electronic tallied data which can be stored can be estimated in correspondence with the storage capacity of the data storage region 2 (14). As a consequence, the use efficiency and the user friendly function for the memory can be improved.

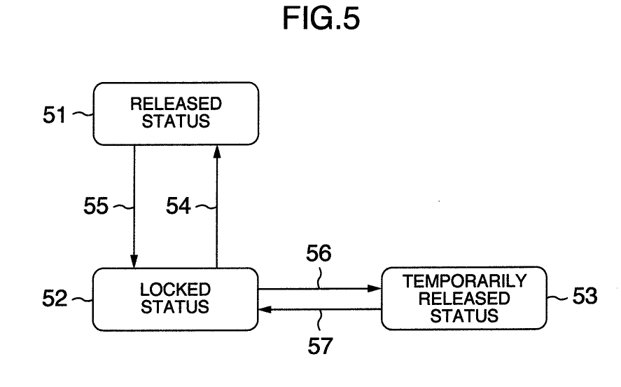

Referring now to FIG. 5, a description is made of operations as to the access control unit 4 of the information terminal apparatus 1 shown in FIG. 1. As indicated in FIG. 5, while the access control unit 4 shown in FIG. 1 possesses three statuses, namely a locked status 52, a released status 51, and a temporarily released status 53, the access control unit 4 has provided these statuses as status signals to the non-volatile memory input/output unit 5 shown in FIG. 1, as previously described.

The locked status 52 corresponds to a status for indicating that a data reading operation from the data storage region 2 (14) of the non-volatile memory 11 shown in FIG. 1 is limited. Also, both the released status 51 and the temporarily released status 53 correspond to statuses for indicating that data reading operation from both the data storage region 1 (13) and the data storage region 2 (14) of the non-volatile memory 11 shown in FIG. 1 can be freely carried out.

An initial condition just after the power supply is turned ON is any one of the locked status 52 and the released status 51, which may be selected by the user.

A transition 54 from the locked status 52 to the released status 51 occurs when an instruction for permitting a data reading operation with respect to the information terminal apparatus 1 shown in FIG. 1 is notified as an external input via the central control unit 6 to the access control unit 4, and the access control unit 4 recognizes justification of this read permission instruction. Also, another transition 55 from the release status 51 to the locked status 52 occurs when an instruction not for permitting a data reading operation with respect to the information terminal apparatus 1 shown in FIG. 1 is notified as an external input via the central control unit 6 to the access control unit 4, and the access control unit 4 recognizes justification of this read non-permission instruction.

A concrete example for determining the above-described status 54 and the above-explained status 55 is such an authentication executed based upon biological information, for instance, a password and a finger print, which is given by the user as the above-described external inputs.

Another transition 56 from the locked status 52 to the temporarily released status 53 occurs when reception notification issued by the communication control unit 3 employed in the information terminal apparatus 1 shown in FIG. 1 is transferred via the central control unit 6 to the access control unit 4. Also, a further transition 57 from the temporarily released status 53 to the locked status 52 occurs when the central control unit 6 shown in FIG. 1 has accomplished a reading operation of desirable electronic data from the data storage region 2 (14) of the non-volatile memory 11, and then, completion notification issued from the central control unit 6 as an origination factor of this completion is received. The operations as to the access control unit 4 of the information terminal apparatus 1 indicated in FIG. 1 have been described in the above-explained descriptions.

Referring again to FIG. 1, a description is made of both a writing operation when electronic tally-subject data and electronic non-tally-subject data are newly stored in the non-volatile memory 11, and a reading operation when electronic tally-subject data and electronic non-tally-subject data stored in the non-volatile memory 11 are acquired, and also, functions and operations of the respective structural units employed in the information terminal apparatus 1 will now be explained in a supplementary manner.

### (Writing Operation)

Firstly, in the central control unit 6, the electronic tally-subject data formed by the electronic tally application program 7 is divided by the electronic tally processing unit 9 into “N” (N>1) pieces of electronic tallied data on the volatile memory (omitted in FIG. 1); and concretely speaking, in such a case that the dividing number “N” is 2, the central control unit 2 produces first electronic tallied data and second electronic tallied data. Although a description will be made that the dividing number “N” is 2, this assumption does not impede a generality. Also, while the central control unit 6 holds sizes of the respective electronic tallied data which have been produced, the central control unit 6 uses the held sizes when a file table of management information is formed (will be explained later).

Next, the central control unit 6 refers to the management information held by the data managing unit 10 so as to determine storage locations as to the first electronic tallied data and the second electronic tallied data in the non-volatile memory 11, namely to determine storage destination addresses thereof. Concretely speaking, the central control unit 6 scans the first bitmap 23 and the second bitmap 24 shown in FIG. 2 so as to seek empty regions, and determines bitmap numbers capable of recording the first electronic tallied data and the second electronic tallied data based upon the data size of the electronic tally data. Then, the central control unit 6 forms a file table of the management information. Furthermore, the central control unit 6 converts the determined bitmap numbers as to the first electronic tallied data and the second electronic tallied data into storage destination addresses.

The central control unit 6 transfers the determined storage destination addresses to the non-volatile memory input/output unit 5; the non-volatile memory input/output unit 5 controls the interface based upon a predetermined procedure (protocol) so as to issue a write request with respect to the non-volatile memory 11; and subsequently, the non-volatile memory input/output unit 5 transmits the first electronic tallied data to the data storage region 1 (13) of the non-volatile memory 11, and transmits the second electronic tallied data to the data storage region 2 (14) thereof; and then, the central control unit 6 accomplishes the writing operation.

On the other hand, with respect to the electronic non-tally-subject data which is handled by the electronic non-tally application program 8, the central control unit 6 refers to the management information held by the data managing unit 10 so as to determine a storage destination address in the data storage region 1 (13). Concretely speaking, the central control unit 6 scans the first bitmap 23 shown in FIG. 2 so as to seek an empty region, and determines a bitmap number capable of recording the electronic non-tally-subject data based upon the data size of the electronic non-tally-subject data. Then, the central control unit 6 forms a file table of the management information. Furthermore, the central control unit 6 converts the determined bitmap number as to the electronic non-tally-subject data into a storage destination address.

The central control unit 6 transfers the determined storage destination address to the non-volatile memory input/output unit 5; the non-volatile memory input/output unit 5 controls the interface based upon a predetermined procedure (protocol) so as to issue a write request with respect to the non-volatile memory 11; and subsequently, the non-volatile memory input/output unit 5 transmits the electronic non-volatile-subject data to the data storage region 1 (13) of the non-volatile memory 11, and then, the central control unit 6 accomplishes the writing operation.

### (Reading Operation)

First of all, with respect to such an electronic tally-subject data which is desired by the electronic tally application program 7, the central control unit 6 refers to the file table of the management information possessed by the data managing unit 10 so as to acquire storage destination addresses of the above-described electronic tally-subject data which have been stored in both the data storage region 1 (13) and the data storage region 2 (14) of the non-volatile memory 11. Concretely speaking, the central control unit 6 seeks file names of the respective file tables, and after the file names have been found out, the central control unit 6 refers to an index of the file table. Then, the central control unit 6 acquires the bitmap numbers as to the first electronic tallied data and the second electronic tallied data in order to restore the above-described electronic tally-subject data, and converts the acquired bitmap numbers into storage destination addresses.

The central control unit 6 transfers the acquired storage destination addresses to the non-volatile memory input/output unit 5 in a continuous manner; and the non-volatile memory input/output unit 5 controls the interface based upon a predetermined procedure (protocol) so as to issue a read request with respect to the non-volatile memory 11; and the central control unit 6 accomplishes the reading operation. At this time, the non-volatile memory input/output unit 5 refers to a status signal sent from the access control unit 4, and when this status signal corresponds to either the released status or the temporarily released status, the non-volatile memory input/output unit 5 issues a read request with respect to both the data storage region 1 (13) and the data storage region 2 (14) of the non-volatile memory 11. On the other hand, when the above-described status signal corresponds to the locked status, although the non-volatile memory input/output unit 5 issues a read request with respect to the data storage region 1 (13) of the non-volatile memory 11, but the non-volatile memory input/output unit 5 does not issue the read request with respect to the data storage region 2 (14) of the non-volatile memory 11, and returns dummy data which is constructed all of, for instance, “0.”

The central control unit 6 transfers 2 pieces of the electronic tallied data returned from the non-volatile memory input/output unit 5 to the electronic tally processing unit 9; and the electronic tally processing unit 9 restores the original electronic tally-subject data from the first electronic tallied data and the second electronic tallied data, and then, transfers the restored original electronic tally-subject data to the electronic tally-subject application program 7. At this time, when the second tallied data is such a dummy data made of all “0”, the electronic tally processing unit 9 cannot restore the original tally-subject data.

On the other hand, with respect to the electronic non-tally-subject data which is handled by the electronic non-tally application program 8, the central control unit 6 refers to the file tables of the management information held by the data managing unit 10 so as to acquire a storage destination address in the data storage region 1 (13) of the non-volatile memory 11. Concretely speaking, the central control unit 6 seeks file names of the respective file tables, and after the file names have been found out, the central control unit 6 refers to an index of the file table. Then, the central control unit 6 acquires a bitmap number and converts the acquired bitmap number into a storage destination address.

The central control unit 6 transfers the acquired storage destination address to the non-volatile memory input/output unit 5; and the non-volatile memory input/output unit 5 controls the interface based upon a predetermined procedure (protocol) so as to issue a read request.

The central control unit 6 transfers the electronic non-tally-subject data returned from the non-volatile memory input/output unit 5 to the electronic non-tally application program 8.

In the above-described explanations, the information terminal apparatus 1 to which the electronic tally system has been applied, according to the first embodiment of the present invention, have been described.

In accordance with the information terminal apparatus 1 according to the first embodiment of the present invention, to which the electronic tally system has been applied, the electronic tally-subject data handled by the electronic tally-subject application program is stirred and is divided based upon the electronic tally system so as to produce the plurality of electronic tallied data; and then, the produced electronic tallied data are stored in the data storage region 1 and the data storage region 2 of the non-volatile memory, so that the information terminal apparatus possesses the electronic tally-subject data in an imperfect mode. Then, in such a case that the status signal provided by the access control unit corresponds to the locked status, the non-volatile memory input/output unit does not perform at all the reading operation of the electronic tallied data which is stored in the data storage region 2. As a consequence, it is possible to realize that the electronic tally-subject data can be hardly restored by the illegal user, and even when the electronic tallied data are present in the physically same memory, the security thereof can be secured.

Also, even when the above-described status signal is under the locked status, this locked status can be transferred to the temporarily released status while the telephone call reception and the electronic-mail reception are defined as the origination factor. As a result, the electronic tallied data can be read from the data storage region 2. As a consequence, the telephone call receiving person and the electronic-mail receiving person can be specified, and the user friendly function is not deteriorated even while the security is secured.

Furthermore, the management information possessed by the data managing unit handles the electronic tally-subject data not with respect to each of the divided electronic tallied data, but handles the above-described electronic tally-subject data as a unit. As a result, it is possible to suppress that the management information is increased and becomes complex, so that the electronic tally-subject data can be managed by employing such a memory having a small storage capacity.

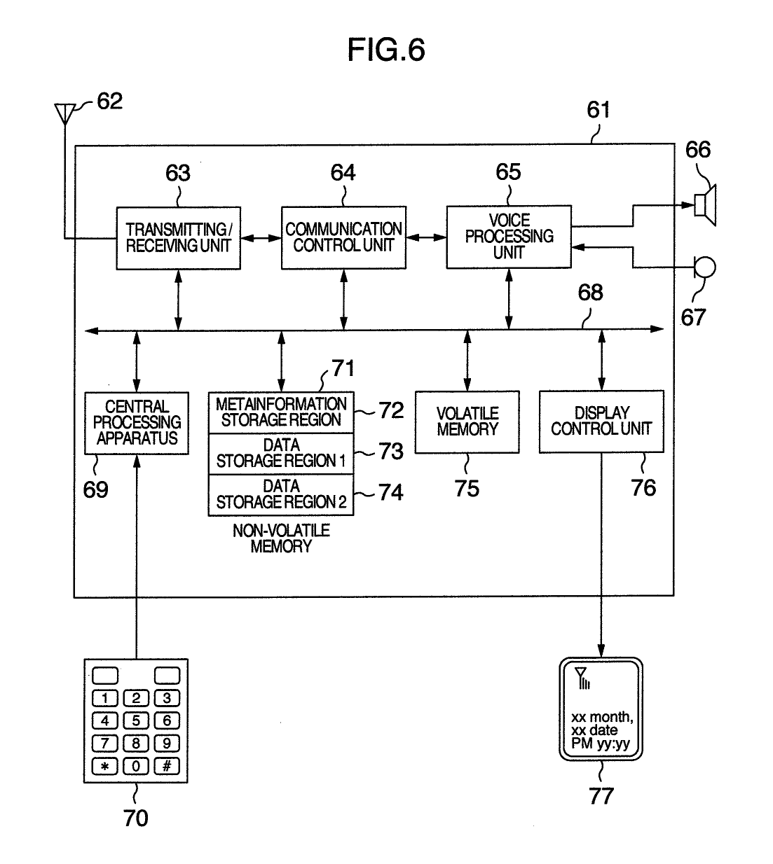

Referring now to FIG. 6, a description is made of an arrangement of a portable telephone apparatus 61 which is a concrete example as to the information terminal apparatus 1 where the electronic tally system has been applied, according to the first embodiment of the present invention.

As shown in the drawing, the portable telephone apparatus 61 is arranged by an antenna 62, a speaker 66, a microphone 67, a display unit 77, an operation key 70, a transmitting/receiving unit 63, a communication control unit 64, a voice processing unit 65, a non-volatile memory 71, a display control unit 76, a volatile memory 75, and a central processing apparatus 69. The antenna 62 is employed in order to transit/receive electromagnetic waves. The speaker 66 is provided so as to inform voice sent from a telephone communication counter party to a user, and also to notify a telephone call. The microphone 67 is used in order to acquire voice of the user. The display unit 77 is constituted by a menu screen for selecting a telephone number, an electronic-mail address, and various sorts of functions provided by an application program, and further constituted by a liquid crystal display for displaying thereon a present time instant and electromagnetic conditions. The operation key 70 provides a direct interface with respect to the user, while the operation key 70 is constituted by ten key buttons, selection buttons of functions, and a decision button in order that a telephone number and a character are inputted; an application program is selected to be determined; a telephone calling operation, a mail transmitting operation, a telephone call receiving operation, and a mail reception are determined; and the power supply of the portable telephone apparatus 61 is turned ON/OFF. The transmitting/receiving unit 63, the communication control unit 64, and the voice processing unit 65 constitute a communication means for transmitting/receiving a telephone call and electronic data. The non-volatile memory 71 is employed in order that an electric mail, a browser, and a telephone directory are stored as electronic tallied data, which are related to personal information of the user who possesses the portable telephone apparatus 61; and software programs related to an electronic tally application program, an electronic non-tally application program, and other application programs. The display control unit 76 is employed so as to display various sorts of information such as a moving picture, a still image, and a text on the display unit 77. The volatile memory 75 is mainly constructed of a RAM (Random Access Memory) and is provided in order that data is observed and updated in a high speed, and also data is temporarily stored thereinto. The central processing apparatus 69 is mainly arranged by a CPU (Central Processing Unit), and a controller for controlling an interface between a volatile memory and a non-volatile memory, while the central processing apparatus 69 controls the above-described communication means, and executes the various sorts of application programs. The transmitting/receiving unit 63, the communication control unit 64, the voice processing unit 65, the central processing apparatus 69, the non-volatile memory 71, the volatile memory 75, and the display control unit 76 have been coupled to each other via a bus 68 in order that necessary information can be mutually transferred/received.

While the central processing apparatus 69 contains the central control unit 6, the access control unit 4, and the non-volatile memory input/output unit 5 represented in FIG. 1, the central processing apparatus 69 executes the electronic tally application program 7 and the electronic non-tally application program 8 which are realized as the software program, and the management information of the data managing unit 10, and the electronic tally processing unit 9.

The non-volatile memory 71 corresponds to the above-described non-volatile memory 11 shown in FIG. 1, and is constructed of a semiconductor flash memory. The non-volatile memory 71 has been constituted by a metainformation storage region 72 for storing thereinto the above-described management information; a data storage region 1 (73) for storing thereinto electronic data which is handled by the electronic non-tally application program 8; and one of the electronic tally-subject data which are handled by the electronic tally application program 8; and a data storage region 2 (74) for storing thereinto the other data of the electronic tally data. This non-volatile memory 71 has been arranged so as to control a reading operation from the data storage region 2 (74) by the central processing apparatus 69.

In the case that information received via the antenna 62 by the transmitting/receiving unit 63 is not such an information which should be protected, the central processing apparatus 69 stores the received information into the data storage region 1 (73) of the non-volatile memory 71 without performing a tally encrypting process operation. In the case that information received via the antenna 62 by the transmitting/receiving unit 63 is such an information which should be protected, the central processing apparatus 69 performs the tally encrypting process operation with respect to the received information, and then, stores the tally-encrypting-processed information into both the data storage region 1 (73) and the data storage region 2 (74). Also, when an access is made from an external source via the antenna 62, if this access is made from a justified access terminal, then the central processing apparatus 69 reads out the electronic tallied data from the data storage region 2 (74), and re-constructs original electronic data in conjunction with the electronic tallied data read out from the data storage region 1 (73), and then, controls the communication control unit 64, the transmitting/receiving unit 63, and the antenna 62 so as to transmit the re-constructed original electronic data.

As previously described, in such a portable telephone that resources such as a memory storage and processing performance of a processor are limited, as compared with those of a PC (personal computer), since this embodiment is applied to the above-described portable telephone, there are specific effects that the memory may be effectively utilized, and the processing load may be reduced.

### Second Embodiment

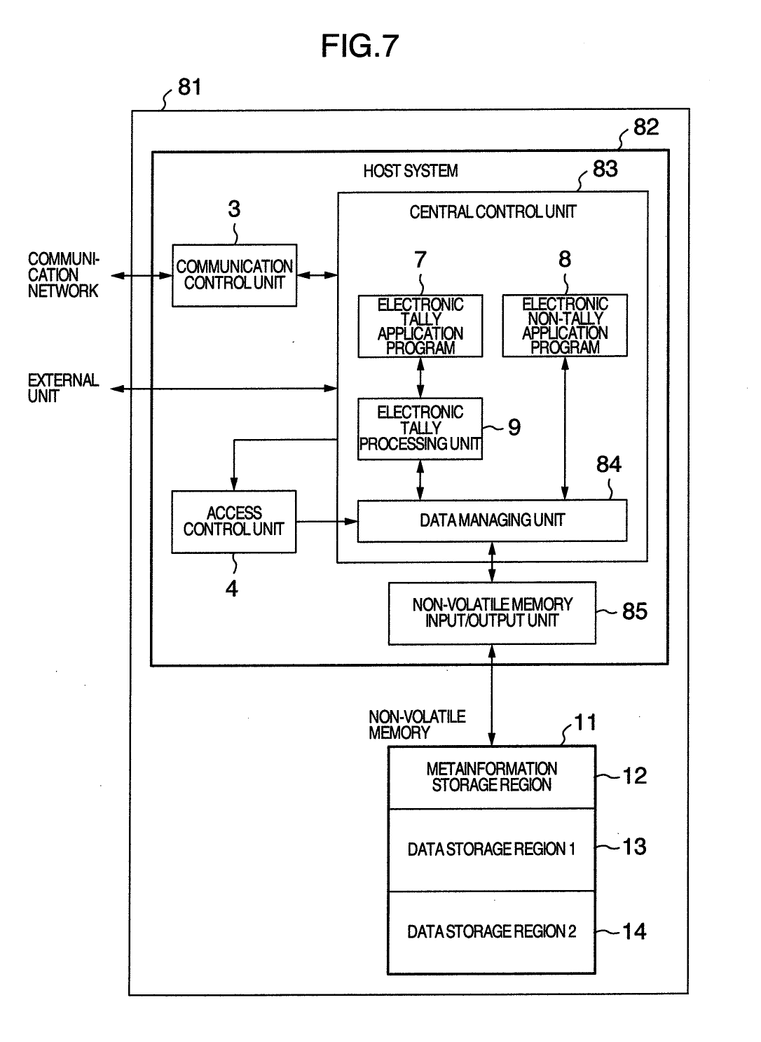

FIG. 7 indicates an information terminal apparatus 81 to which the electronic tally system has been applied, according to a second embodiment of the present invention.

The information terminal apparatus 81 shown in FIG. 7 has the following different structural point, as compared with the structure of the information terminal apparatus 1 indicated in FIG. 1: That is, a status signal outputted by an access control unit 4 has been firstly provided with respect to a data managing unit 84 of a central control unit 82.

The access control unit 4 of the information terminal apparatus 81 is equipped with an authentication mechanism which confirms justification of a user instruction given via the central control unit 83 as an external input. The access control unit 4 provides a status signal for judging whether or not a data reading operation from a non-volatile memory 11 is carried out with respect to the data managing unit 84 in accordance with the authenticated user instruction and such an instruction which is issued by the central control unit 83 in response to the above-described reception notification issued by a communication control unit 3 as an origination factor.

Also, a non-volatile memory input/output unit 85 provides a physical interface to a non-volatile memory 11 based upon a write instruction and a write destination address, or a read instruction and a read destination address. The write instruction and the write destination address are given from the central control unit 83 so as to store various sorts of electronic data handled by the information terminal apparatus 81 into the non-volatile memory 11. The read instruction and the read destination address are given from the central control unit 83 so as to read out various sorts of electronic data from the non-volatile memory 11.

In addition, the data managing unit 84 of the central control unit 83 performs the below-mentioned process operations: That is, while a read request for electronic tally-subject data is issued, at this time, when the data managing unit 84 refers to a status signal issued by the access control unit 4, if this status signal is under locked status, then the data managing unit 84 does not accept the above-described read request, for example, notifies a read error with respect to an electronic tally application program 7.

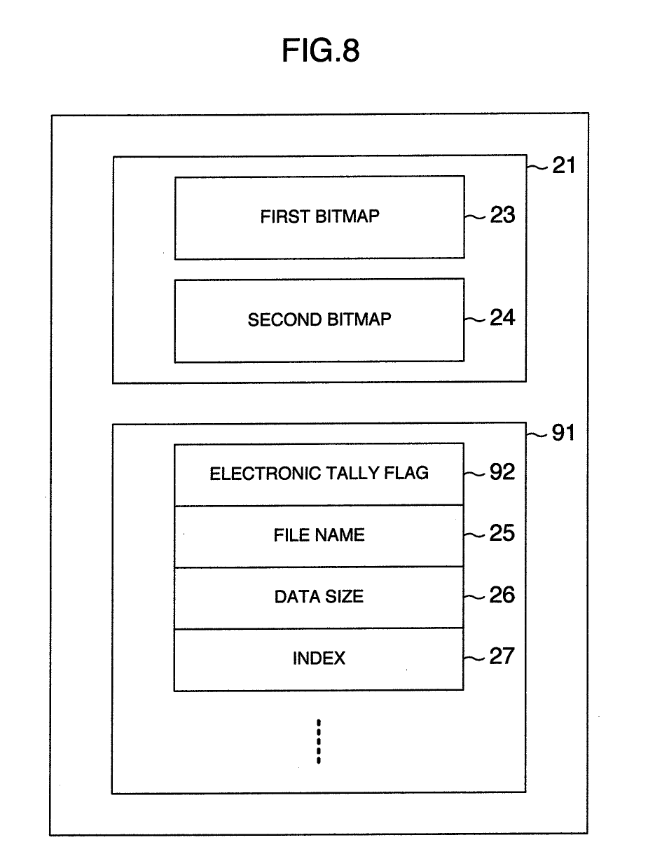

Next, referring now to FIG. 8, a description is made of a structure of management information which is possessed by the data managing unit 84 shown in FIG. 7.

As shown in this drawing, in comparison with the management information represented in FIG. 2, there is such a structural different point that an electronic tally flag 92 is newly provided in a file table 91. As the above-described electronic tally flag 92, when electronic data (either electronic tally-subject data or electronic non-tally-subject data) is newly stored in the non-volatile memory 11, if the above-described electronic data corresponds to the electronic tally-subject data, then “1” is described, whereas if the above-explained electronic data corresponds to the electronic non-tally-subject data, then “0” is described. Concretely speaking, the above-described flag setting operation is achieved by that the data managing unit 84 shown in FIG. 7 discriminates the request issued from the electronic tally application program 7 from the request issued form the electronic non-tally application program 8.

With reference to FIG. 7, a description is made of a reading operation when electronic tally-subject data handled by the information terminal apparatus 81 is acquired from the non-volatile memory 11, and both functions and operations of the respective structural units provided in the information terminal apparatus 81 are explained in a supplementary manner.

### (Reading Operation)

Firstly, the central control unit 83 refers to file tables of the management information possessed by the data managing unit 84, and a status signal issued from the access control unit 4 with respect to electronic data which is wanted by either the electronic tally application program 7 or the electronic non-tally application program 8.

Then, in response to a request issued from the electronic tally application program 7, if the above-described status signal issued from the access control unit 4 corresponds to either the released status or the temporarily released status, then the central control unit 83 acquires storage destination addresses of the above-described electronic tally-subject data which are stored in the data storage region 1 (13) and the data storage region 2 (14) of the non-volatile memory 11. Concretely speaking, first of all, the central control unit 83 refers to the electronic tally flag 92 shown in FIG. 8, and seeks a file name 25 of a file table 91 where the electronic tally flag 92 is “1”, and also, refers to an index 27 after the file name 25 has been found out. Then, the central control unit 83 acquires the bitmap numbers as to the first electronic tallied data and the second electronic tallied data in order to restore the above-described electronic tally-subject data, and converts the acquired bitmap numbers into storage destination addresses. The central control unit 83 transfers the acquired storage destination addresses to the non-volatile memory input/output unit 85 in a continuous manner; and the non-volatile memory input/output unit 85 controls the interface based upon a predetermined procedure (protocol) so as to issue a read request with respect to the non-volatile memory 11; and the central control unit 83 accomplishes the reading operation. The central control unit 83 transfers 2 pieces of the electronic tallied data returned from the non-volatile memory input/output unit 85 to the electronic tally processing unit 9; the electronic tally processing unit 9 restores the original electronic tally-subject data from the first electronic tallied data and the second electronic tallied data, and then, transfers the restored original electronic tally-subject data to the electronic tally-subject application program 7.

On the other hand, in response to a request issued from the electronic tally application program 7, if a status signal issued from the access control unit 4 corresponds to the locked status, then the central control unit 83 notifies such a message that the above-described electronic tally-subject data cannot be read out from the non-volatile memory 11 to the electronic tally application program 7, and accomplishes the reading operation.

Moreover, if a request is issued from the electronic non-tally application program 8, then the central control unit 83 refers to the file table 91 irrespective of the above-described status signal so as to acquire a storage destination address of the electronic non-tally-subject data to be stored in the data storage region 1 (13) of the non-volatile memory 11. Concretely speaking, first of all, the central control unit 83 refers to the electronic tally flag 92 shown in FIG. 8, and seeks the file name 25 of the file table 91 where the electronic tally flag 92 is “0”, and also, refers to the index 27 after the file name 25 has been found out. Then, the central control unit 83 acquires the bitmap number as to the above-described electronic tally-subject data, and converts the acquired bitmap number into a storage destination address. The central control unit 83 transfers the acquired storage destination address to the non-volatile memory input/output unit 85; and the non-volatile memory input/output unit 85 controls the interface based upon a predetermined procedure (protocol) so as to issue a read request with respect to the non-volatile memory 11; and the central control unit 83 accomplishes the reading operation.

The central control unit 83 transfers the electronic non-tally-subject data returned from the non-volatile memory input/output unit 85 to the electronic non-tally application program 8. As previously explained, the information terminal apparatus 81 to which the electronic tally system has been applied, according to the second embodiment of the present invention, has been described.

In accordance with the information terminal apparatus 81 according to the second embodiment of the present invention, to which the electronic tally system has been applied, the central control unit 83 refers to both the file table of the data managing unit 84 and the status signal provided by the access control unit 4, and when the status signal corresponds to the locked status, the central control unit 83 does not completely perform the reading operation of the electronic tallied data. As a consequence, since the electronic tally-subject data can be hardly restored by the illegal user, even when the electronic tallied data are present in the physically same memory, the security thereof can be secured.

In the reading operation, in the electronic tally application program, at this time, if the above-described status signal corresponds to the locked status, then the reading operation is not completely carried out irrespective of the discrimination between the data storage regions 1 and 2. As a result, a transaction occurred between a host system 82 and the non-volatile memory 11 can be reduced, so that the response characteristic to the electronic tally application program 7 can be increased.

In addition, the file table for the management information possessed by the data managing unit 84 has been equipped with the electronic tally flag for indicating whether this file table corresponds to the electronic tally-subject data, or the electronic non-tally-subject data. As a consequence, since the central control unit 83 merely refers to the file table of the corresponding to the electronic tally flag in response to the read request issued from either the electronic tally application program 7 or the electronic non-tally application program 8, the central control unit 83 can perform the retrieving operation in a high speed.

### (Modifications)

In the Information Terminal Apparatuses 1 and 81 of the first embodiment and the second embodiment, the electronic tally processing unit 9 has been constructed in such a manner that “N (N>1)”, or more pieces of the electronic tallied data are produced in arbitrary sizes. Alternatively, the below-mentioned rule may be employed. That is, in accordance with this rule, one piece of the electronic tallied data among “N” pieces of these produced electronic tallied data must have a fixed size, and only this electronic tallied data having the fixed size may be alternatively stored in the data storage region 2 (14) of the non-volatile memory 11.

The above-described fixed size may be determined while, for example, a page size (512 bytes and multiple thereof) of a non-volatile memory is defined as a reference size.

In accordance with such an information terminal apparatus, a storage capacity which should be secured as the data storage region 2 (14) of the non-volatile memory 11 may be previously determined, so that the use efficiency of the non-volatile memory 11 may be increased. For instance, it is so assumed that a total quantity of electronic tally subject data which can be handled by the information terminal apparatus is selected to be 100 pieces, and a fixed size of electronic tallied data produced by the electronic tally processing unit is 512 bytes, a storage capacity which should be secured as the data storage region 2 (14) may be determined as at least 51,200 bytes.

Moreover, since the fixed size is completely made coincident with the page size, the electronic tallied data which are stored in the data storage region 2 (14) can be stored thereinto without being fragmented, and thus, the electronic tallied data can be readily managed.

In accordance with the above-described modified embodiment, the non-volatile memory input/output unit 5, 85 does not perform completely the reading operation of the electronic coded data which is stored in the second data storage region, depending upon the status symbol provided by the access control unit 4. As a result, it is possible to realize that the electronic tally-subject data can be hardly restored by the illegal user, and further, even when the electronic tallied data are present in the physically same memory, the security thereof can be secured.

Also, since the electronic tallied data are managed on the same memory, the risks of losing the electronic tallied data can be reduced, as compared with the losing risks in such a case that the electronic tallied data are separately stored in a detachable external memory for the information terminal apparatus. Also, the user need not pay his attention to such an operation for checking whether or not a communication is permitted, and also, to an overhead of the communication. As a result, the user friendly function of the information terminal apparatus can be improved.

Also, since the electronic tallied data can be temporarily read out from the second data storage region while the telephone call reception and the electronic-mail reception are defined as the origination factor, the telephone call receiving person and the electronic-mail receiving person can be specified. Also, the user friendly function is not deteriorated.

Furthermore, the management information possessed by the data managing unit handles 10, 84 the electronic tally-subject data not with respect to each of the divided electronic tallied data, but handles the above-described electronic tally-subject data as 1 unit. As a result, it is possible to suppress that the management information is increased and becomes complex, so that the electronic tally-subject data can be managed based upon a small amount of information.

It should also be understood that although the access control unit 4 has been separately described in FIG. 1 with respect to the central control unit 6, the function of this access control unit 4 may be alternatively realized as a software process operation executed in the central control unit 6.

As previously described, the present invention is related to such an information terminal apparatus with employment of the electronic data storage system to which the electronic tally system has been applied, and may become effective as the techniques capable of securing the safe functions of the electronic data and also capable of readily managing the produced electronic tallied data in such an information terminal apparatus. More specifically, the present invention may have effects under such an environment that processor performance and memory capacities are limited, as provided in portable telephone apparatuses.

It should be further understood by those skilled in the art that although the foregoing description has been made on embodiments of the invention, the invention is not limited thereto and various changes and modifications may be made without departing from the spirit of the invention and the scope of the appended claims.

1. An information terminal apparatus comprising:
an electronic tally processing unit for dividing original electronic data based upon an electronic tally system so as to produce “N” (N>1) pieces of electronic tallied data, and for re-constructing said original electronic data from said “N” pieces of electronic tallied data;
a data storage unit containing a first data storage region which stores thereinto both “M” (N>M>0) pieces of said electronic tallied data among “N” pieces of said electronic tallied data, and electronic data to which the electronic tally system is not applied, and also containing a second data storage region which stores thereinto the remaining (N-M) pieces of electronic tallied data;
a data input/output unit for writing the electronic tallied data and the electronic data to which the electronic tally system is not applied into said data storage unit, and for reading said written data from the data storage unit; and
an access control unit for controlling a reading operation of the electronic tallied data which is stored in said data storage unit.

2. An information terminal apparatus as claimed in claim 1 wherein:
said access control unit controls a reading operation of the electronic tallied data which is stored in said second data storage region.

3. An information terminal apparatus as claimed in claim 1 wherein:
said information terminal apparatus is further comprised of:
a communication unit for transmitting/receiving information with respect to a communication network; and wherein:
said access control unit controls the reading operation of the electronic tallied data which is stored in said second data storage region under a locked status that the reading operation of the electronic tallied data which is stored in said second data storage region is not carried out in response to an instruction issued from a user, under a temporarily released status that even under said locked status, the reading operation of the electronic tallied data which is stored in said second data storage region can be temporarily carried out in response to another instruction received by said communication unit; and also, under a released status that the reading operation of the electronic tallied data which is stored in said second data storage region can be freely carried out.

4. An information terminal apparatus as claimed in claim 1 wherein:
said electronic tally input/output unit reads the electronic tallied data which is stored in said second data storage region in accordance with the reading control operation by said access control unit.

5. An information terminal apparatus as claimed in claim 3 wherein:
said data storage unit includes a metainformation storage region for storing thereinto metainformation related to the electronic tallied data and the electronic data to which the electronic tally system is not applied; and wherein:
said metainformation contains: bitmap information indicative of use conditions as to the first data storage region and the second data storage region; and file information having a file name, a data size, and an index indicative of a storage location in said data storage unit with respect to each of the electronic data to which the electronic tally system is applied, or each of the electronic data to which the electronic tally system is not applied.

6. An information terminal apparatus as claimed in claim 5 wherein:
said file information contains an electronic flag for representing whether or not the electronic data stored in said data storage unit has been coded based upon the electronic tally system.

7. An information terminal apparatus as claimed in claim 1 wherein:
in the case that said original electronic data is coded based upon an electronic coding system and then the tallied original electronic data is stored in said data storage region, a data size of electronic tallied data which is stored in said second data storage region every said original electronic data is a constant data size.

8. An information terminal apparatus as claimed in claim 7 wherein:
said constant data size of the electronic tallied data is equal to a minimum recording unit, or a multiple of said minimum recording unit, which are determined by a device which constitutes said electronic tally processing unit.

9. An information terminal apparatus as claimed in claim 1 wherein:
said data storage unit is a semiconductor flash memory in which data is erased in a block unit; and a boundary between the first data storage region and the second data storage region is coincident with a boundary between erasing blocks.

10. An information terminal apparatus as claimed in claim 1 wherein:
said data storage unit is an HDD (hard disk drive); and a boundary between the first storage region and the second storage region is coincident with a boundary between logic blocks defined by a file system.

11. An information terminal apparatus as claimed in claim 1 wherein:
said information terminal apparatus is a portable terminal.
